(19) United States
(12) Patent Application Publication
(10) Pub. No.: US 2004/0203601 A1
(43) Pub. Date: Oct. 14, 2004

(54) Method and apparatus for activating a restrictive operating mode of a wireless communication device

(76) Inventors: Matthew James Morriss, Ft. Worth, TX (US); Son Quang Le, Ft. Worth, TX (US); Dennis Walter Weigum, South Lake, TX (US); Daniel Alvarado, Ft. Worth, TX (US); Kevin Christopher Traugott, Georgetown, TX (US)

Correspondence Address: Daniel C. Crilly, Motorola, Inc., Law Department, 8000 West Sunrise Boulevard, Fort Lauderdale, FL, 33322, US

(21) Appl. No.: 10/324,573

(22) Filed: Dec. 19, 2002

(51) Int. Cl. H04M 1/66; H04M 1/68; H04M 3/16; H04Q 7/20

(52) U.S. Cl. 455/411; 455/410; 455/456.1

(57) ABSTRACT

A wireless communication system (100) employs a method and apparatus for activating a restrictive operating mode of a wireless communication device (101) in the event that the wireless device is lost or stolen. The wireless device has stored therein a password (205) associated with placing itself in a restrictive operating mode. Once placed in such a mode, the wireless device is only capable of contacting a restricted target device (107) as determined by either contact information (204) previously stored in the wireless device or the contents of a received message. After the wireless device is lost or stolen, a remote device (105) is used by the wireless device owner or a wireless service provider to send a message containing the password to the wireless device. Upon receiving the message, the wireless device checks for the password and, if present, automatically places itself in the restrictive operating mode.

### CROSS REFERENCE TO RELATED APPLICATIONS

This application is related to pending U.S. application Ser. No. 10/255,340, filed Sep. 26, 2002, entitled “Method and Apparatus for Operating a Lost Mobile Communication Device”, and assigned to Motorola, Inc.

### FIELD OF THE INVENTION

The present invention relates generally to portable wireless communication devices, and, in particular, to remotely or locally programming such a communication device to permit very limited device operation as a precautionary measure or in the event that the device is lost or stolen.

### BACKGROUND OF THE INVENTION

Portable wireless communication devices are well known. Such devices include cellular telephones, personal digital assistants (PDAs), wireless email devices, instant messaging devices, pagers, two-way radios, and portable laptop computers, just to name a few. Depending on the quality thereof and the features contained therein, such devices can be quite expensive. In addition, since such devices are commonly used in connection with many of today's business and personal transactions, such devices may contain confidential or personal information of their users. While user-inputted passwords provide some level of security, such passwords may be broken by sophisticated thieves. As a consequence, the development of other measures to prevent the loss of a wireless communication device or to secure its recovery in the event of a loss is of great importance in today's wireless environment.

Various wireless device loss detection and response approaches presently exist. Such approaches focus primarily on remotely programming the lost device over-the-air (OTA) to (i) prohibit the device from performing certain operations, such as prohibiting the placement of phone calls, and/or (ii) instruct the device to perform certain operations, such as displaying device owner information or erasing certain data stored in the device, in an attempt to increase the user's chances of recovering the device or protecting data stored in the device. While prohibiting call placement clearly limits the device owner's exposure for service fees associated with unauthorized phone calls, such an approach has some undesirable or unintended effects, such as preventing the possessor of the device from being able to use the device to contact the device's owner. In addition, while displaying contact information for the device owner may encourage the possessor of the device to call the owner to facilitate a return of the device, such an approach relies on the morality of the possessor to act on such information and call the device owner before running up the phone bill.

Therefore, a need exists for a method and apparatus for remotely implementing security in a wireless device that, inter alia, facilitates the return of a lost or stolen device, without relying solely on the lost device possessor's moral compass or completely prohibiting wireless device communications.

### BRIEF DESCRIPTION OF THE DRAWINGS

FIG. 1 is an electrical block diagram of an exemplary wireless communication system in accordance with the present invention.

FIG. 2 is an electrical block diagram of an exemplary wireless communication device for use in the system of FIG. 1.

FIG. 3 is an electrical block diagram of an exemplary remote programming device for use in OTA programming the wireless communication device of FIG. 2 in the event that the wireless communication device is lost or stolen.

FIG. 4 is a logic flow diagram of steps executed by a wireless communication device to implement security therein in accordance with a preferred embodiment of the present invention.

FIG. 5 is a logic flow diagram of steps executed by a remote programming device to remotely activate a restrictive operating mode of a wireless communication device in accordance with a preferred embodiment of the present invention.

### DETAILED DESCRIPTION OF A PREFERRED EMBODIMENT

Generally, the present invention encompasses a method and apparatus for remotely activating a restrictive operating mode of a wireless communication device in the event that the wireless device is lost or stolen. The wireless device has stored therein a password associated with placing itself in a restrictive operating mode. Once placed in the restrictive operating mode, the wireless device is only capable of contacting a restricted target device as determined by either contact information previously stored in the wireless device or the contents of a received message. After the wireless device is lost or stolen, a remote device is used by the wireless device owner or a wireless service provider to generate and transmit a message containing the password and possibly other information, such as contact information for a target device used by the wireless device owner or the wireless service provider. Upon receiving the message from the remote device, the wireless device checks for the password and, if present, automatically places itself in the restrictive operating mode. By providing wireless device security in this manner, the present invention increases the chances of the device owner or his or her wireless service provider being contacted in the event that the wireless device is lost or stolen, while mitigating wireless service charges that could otherwise be incurred as a result of unauthorized use of the lost wireless device.

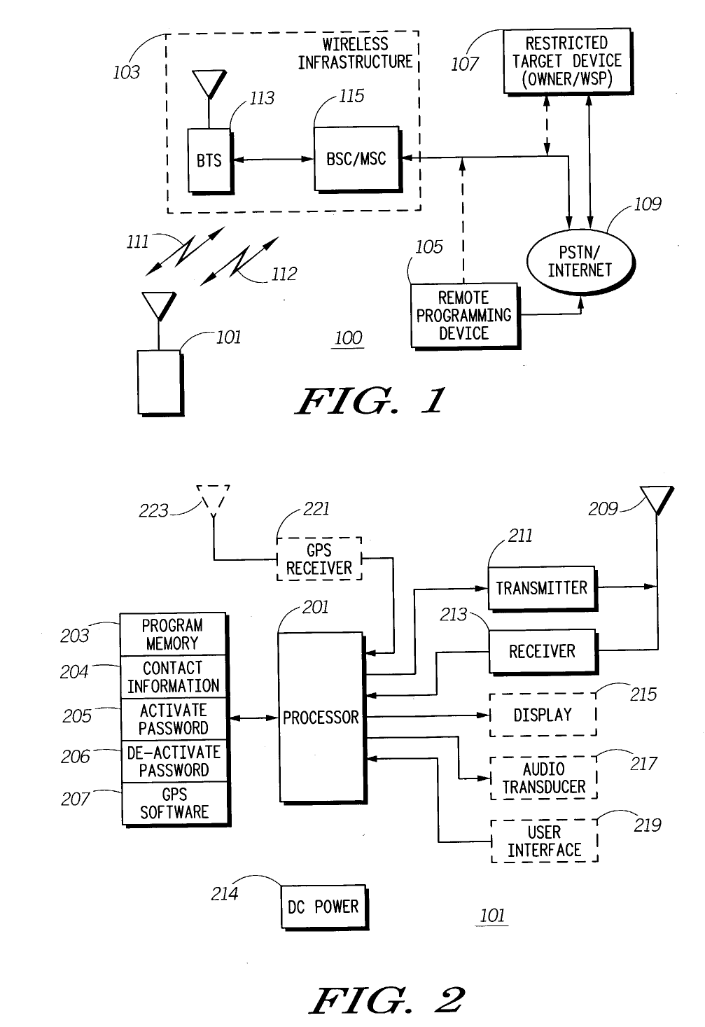

The present invention can be more fully understood with reference to FIGS. 1-5, in which like reference numerals designate like items. FIG. 1 is an electrical block diagram of an exemplary wireless communication system 100 in accordance with the present invention. The communication system 100 includes, inter alia, one or more wireless communication devices 101 (one shown), a wireless infrastructure 103, a remote programming device 105 and one or more restricted target devices 107 (one shown). The wireless infrastructure 103 facilitates wireless communications in the system 100 and interconnects the system 100 with other networks 109, such as the public switched telephone network (PSTN) and the Internet, in accordance with conventional techniques. Communication between the wireless communication device 101 and the wireless infrastructure 103 occurs over one or more wireless communication channels 111-112 (two shown) in accordance with the protocol of the particular wireless communication system 100. The types of wireless communication systems that are of particular interest in connection with the present invention are any and all systems that provide or facilitate voice and/or data services.

The wireless communication device 101 preferably comprises a conventional portable communication device, such as a cellular phone, pager, PDA, two-way radio, laptop computer or any other portable communication device adapted preferably through software modifications to carry out the present invention. An exemplary embodiment of the wireless communication device 101 is described below with respect to FIG. 2.

The wireless infrastructure 103 comprises components and software necessary to facilitate wireless communications in the particular type of communication system 100 in which the present invention is employed. For example, in a conventional cellular phone system, the wireless infrastructure 103 includes, inter alia, a conventional base transceiver site (BTS) 113, a base site controller (BSC), and a mobile switching center (MSC) (the latter two being shown collectively as BSC/MSC 115). The wireless infrastructure 103 would also include various other components, such as routers, splitters, combiners, modems, alternating current (AC) power distribution systems, and so forth, as would be known by those skilled in the art in order to fully construct an operable infrastructure implementation.

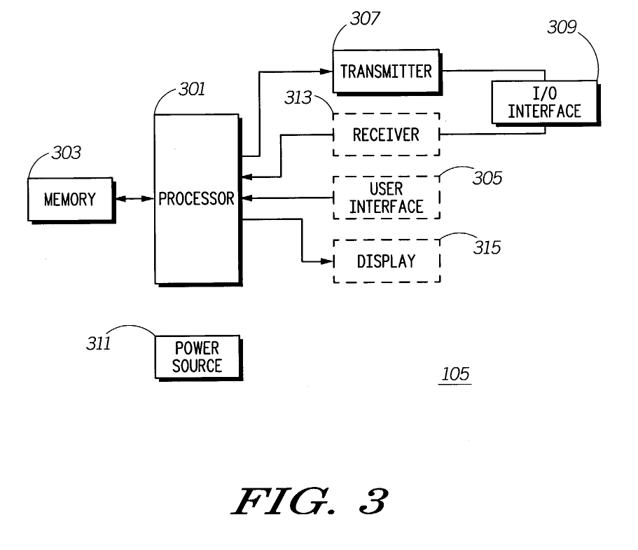

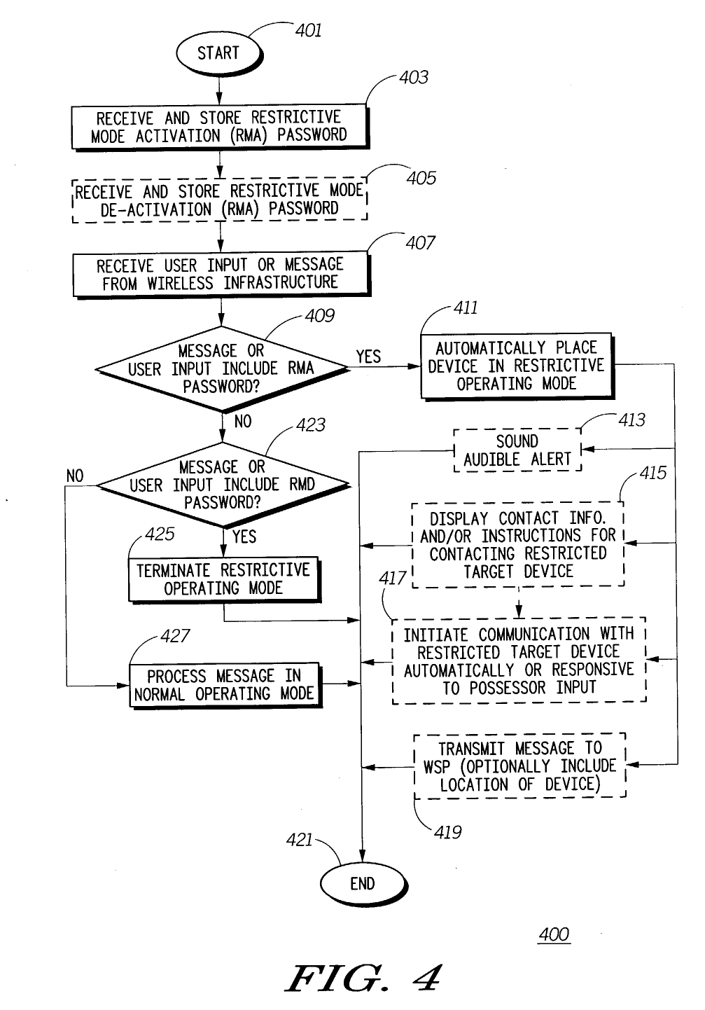

The remote programming device 105 preferably comprises a computer, a server or other data-capable device that is operably coupled to the wireless infrastructure either directly (e.g., as may be the case if the remote programming device 105 is maintained by the wireless service provider that operates the wireless communication system 100) or indirectly through some other network 109. An exemplary embodiment of the remote programming device 105 is described below with respect to FIG. 3.

Each restricted target devices 107 preferably comprises any voice and/or data communication device that is accessible by the wireless device user or the system's wireless service provider (WSP). For example, a restricted target device 107 may be a computer or telephone associated with the wireless service provider's customer service or support group or the home telephone of the wireless device owner. The identification (ID) of or other contact information for each restricted target device 107 (e.g., Internet protocol (IP) address, email address, telephone number, pager number, facsimile number, private dispatch ID, or any other electronic address) is stored in a memory of the wireless communication device 101 a priori or is supplied to the wireless communication device 101 as part of an OTA programming message after the wireless device 101 is determined or reported to be lost or stolen. A priori storage of the restricted device contact information and transmission of the restricted device contact information in an OTA programming message are described in more detail below.

FIG. 2 is an electrical block diagram of an exemplary wireless communication device 101 for use in the system 100 of FIG. 1. The wireless device 101 includes, inter alia, a processor 201, one or more memories 203-207 (five shown) operably coupled to the processor 201, an antenna 209, a transmitter 211, a receiver 213, and a direct current (DC) power source 214. The wireless device 101 may further optionally include a display 215, an audio transducer 217, a user interface 219, a global positioning satellite (GPS) receiver 221, and a GPS antenna 223.

All of the components of the wireless device 101 are wholly or partially contained within a housing. The housing may be fabricated in any conventional manner (e.g., as molded plastic) and implemented in a relatively straight arrangement (often referred to as a “candy bar” arrangement) or in a collapsible arrangement in which two or more housing members are mechanically coupled together through use of a hinge (e.g., in a flip phone implementation), bearings, a cam and/or a cam follower (e.g., in a twist or rotational phone implementation), or any other conventional means that allows the housing members to move relative to each other. In the collapsible arrangement, some of the wireless device components may reside in each housing member.

The processor 201 preferably includes one or more microprocessors, microcontrollers, digital signal processors (DSPs), state machines, logic circuitry, or any other device or devices that process information based on operational or programming instructions. Such operational or programming instructions are preferably stored in program memory 203, which program memory 203 may be an integrated circuit (IC) memory chip containing any form of random access memory (RAM) or read only memory (ROM), a floppy disk, a compact disk read only memory (CD-ROM), a digital versatile disk (DVD), a flash memory card or any other medium for storing digital information. One of ordinary skill in the art will recognize that when the processor 201 has one or more of its functions performed by a state machine or logic circuitry, the program memory 203 containing the corresponding operational instructions may be embedded within the state machine or logic circuitry. The operations performed by the processor 201 and the rest of the wireless device components are described in detail below. While the novel aspects of the present invention are preferably implemented in software and/or as software control of various communication device components, those of ordinary skill in the art will readily appreciate that the wireless device 101 may be implemented solely in hardware, using conventional digital logic components, or partially in hardware and partially in software executed by the processor 201. The processor 201 and the program memory 203 may form part of the central processor and memory used by the portable electronic device 100 to perform many of the device's conventional functions.

Similar to program memory 203, memories 204-207 may be IC memory chips containing any form of RAM or ROM, a floppy disk, a CD-ROM, a DVD, a flash memory card or any other medium for storing digital information. Alternatively, and more preferably, memories 204-206 are simply registers in a single, larger memory that includes one or more of memories 203 and 207. Memory 204 is preferably used to store information for contacting a restricted target device 107 in the event that the wireless device 101 is remotely programmed or instructed to begin operating in a restricted mode of operation subsequent to being lost or stolen. Memory 205 is used to store a password that, when received in a message from the remote programming device 105, causes the wireless device processor 201 to begin operating the wireless device in the restrictive operating mode. Memory 206 is preferably used to store a password that, when received as an input from the wireless device's user interface 219 or when received in a message from the remote programming device 105, causes the wireless device processor 201 to resume operating the wireless device 101 in its normal operating mode. Memory 207 is preferably used to store software or programming instructions associated with processing data received from the wireless device's GPS receiver 221 when such receiver 221 is so included in the wireless device 101.

Memories 204, 206, and 207 would only be included when the communication device 101 included applicable optional functionality. For example, memory 204 need be included only when the wireless device 101 is implemented so as to permit a priori storage of restricted target device contact information. Similarly, memory 206 need be included only when the wireless device 101 is implemented so as to permit user or remote deactivation of the restrictive operating mode. Alternatively, in an embodiment in which the password that activates the restrictive operating mode is also the password that returns the wireless device 101 to its normal operating mode, memory 206 need not be included at all. Finally, memory 207 need be included only when the wireless device 101 is implemented so as to include a GPS receiver 221.

The antenna 209, the transmitter 211 and the receiver 213 are well-known components of conventional wireless communication devices. The antenna 209 may be any conventional antenna designed and configured to facilitate radio transmissions at the radio or microwave frequencies used in the wireless communication system 100. The transmitter 211 and the receiver 213 enable the wireless communication device 101 to communicate information (voice and/or data) to and acquire information from the wireless infrastructure 103 or another wireless communication device. In this regard, the transmitter 211 and the receiver 213 include appropriate, conventional circuitry to enable digital or analog transmissions over a wireless traffic channel 111 (for voice and/or data payload) and a wireless control channel 112 (for control information). Although not shown in FIG. 2, the wireless communication device 100 may optionally include an antenna switch, duplexer, circulator or other means of isolating the receiver 213 from the transmitter 211 in accordance with known techniques.

The implementations of the transmitter 211 and the receiver 213 depend on the implementation of the wireless device 101. For example, the transmitter 211 and the receiver 213 may be implemented as an appropriate wireless modem, or as conventional transmitting and receiving components of two-way wireless devices. In the event that the transmitter 211 and the receiver 213 are implemented as a wireless modem, the modem may be internal to the wireless device 101 or insertable into the wireless device 101 (e.g., embodied in a commercially available wireless radio frequency (RF) modem implemented on a wireless transceiver card that complies with the Personal Computer Memory Card International Association (PCMCIA) standard). For a wireless telephone, pager or two-way radio, the transmitter 211 and the receiver 213 are preferably implemented as part of the wireless device hardware and software architecture in accordance with known techniques. One of ordinary skill in the art will recognize that most, if not all, of the functions of the transmitter 211 and/or the receiver 213 may be implemented in processor 201 or some other processor or controller. However, the processor 201, the transmitter 211, and the receiver 213 have been artificially partitioned herein to facilitate a better understanding of the present invention.

The DC power source 214 preferably comprises a single battery or an arrangement of batteries, although other DC power sources, such as fuel cells may be utilized. The DC power source 214 supplies DC power for use by all the electrical components of the portable wireless device 101.

The display 215, when utilized, preferably comprises a liquid crystal display (LCD), an electronic ink display, a light emitting diode (LED) display, an organic LED (OLED) display, a liquid plasma display, or any other conventional electronic display. The display 215 may be implemented as a single display or as a combination of displays. The audio transducer 217, when utilized, preferably comprises a conventional low power speaker.

The user interface 219, when utilized, may be any conventional user interface mechanism, including without limitation, a keypad, a touchscreen, a keyboard, a joystick, a rollerball, a thumbwheel, a set of scroll buttons, a graphical user interface (GUI), a mouse, or any combination of the foregoing devices. In the event that the wireless device 101 supports voice-activated operation or is a two-way wireless voice- capable device, the user interface 219 may include a microphone(s) or other acoustic receptor(s) to facilitate such operation.

The GPS receiver 221 and antenna 223, when utilized, are conventional devices that receive, decode and process positioning signals emanating from a constellation of GPS satellites (not shown) that are orbiting the earth. The GPS receiver 221 operates in conjunction with an accompanying set of software stored in memory 207 to calculate a location of the wireless device 101 in accordance with known techniques.

FIG. 3 is an electrical block diagram of an exemplary remote programming device 105 for use in OTA programming the wireless communication device 101 of FIG. 2 in the event that the wireless communication device 101 is lost or stolen. The remote programming device 105 includes, inter alia, a processor 301, one or more memories 303 (one shown) operably coupled to the processor 301, a transmitter 307, an input/output (I/O) interface 309, and a power source 311. The remote programming device 105 may further optionally include a user interface 305, a receiver 313 and a display 315, among other things.

All of the components of the remote programming device 105 are wholly or partially contained within one or more housings. The housing(s) may be fabricated in any conventional manner (e.g., as molded plastic) and constructed as single or multi- piece units depending on the particular implementation. For example, when the remote programming device 105 is a personal or desktop computer, one housing may enclose components 301-313 and another housing may enclose the display 315. Alternatively, when the remote programming device 105 is a wireless device or wireline telephone the housing may be implemented in a “candy bar” arrangement or in a collapsible arrangement in which two or more housing members are mechanically coupled together through use of a hinge (e.g., in a flip phone implementation), bearings, a cam and/or a cam follower (e.g., in a twist or rotational phone implementation), or any other conventional means that allows the housing members to move relative to each other. In the collapsible arrangement, some of the remote programming device components may reside in each housing member.

Like its counterpart in the wireless device 101, the processor 301 preferably includes one or more microprocessors, microcontrollers, DSPs, state machines, logic circuitry, or any other device or devices that process information based on operational or programming instructions. Such operational or programming instructions are preferably stored in memory 303, which memory 303 may be an IC memory chip containing any form of RAM or ROM, a floppy disk, a CD-ROM, a DVD, a flash memory card, a hard disk, or any other medium for storing digital information. One of ordinary skill in the art will recognize that when the processor 301 has one or more of its functions performed by a state machine or logic circuitry, the memory 303 containing the corresponding operational instructions may be embedded within the state machine or logic circuitry. The processor 301 may be located in a single device or may be distributed between devices (e.g., between a PC and a server). The operations performed by the processor 301 and the rest of the remote programming device components are described in detail below. While the novel aspects of the present invention are preferably implemented in software and/or as software control of various components, those of ordinary skill in the art will readily appreciate that the remote programming device 105 may be implemented solely in hardware, using conventional digital logic components, or partially in hardware and partially in software executed by the processor 301. The processor 301 and the memory 303 may form part of the central processor and memory used by the remote programming device 105 to perform many of the device's conventional functions.

The transmitter 307, the receiver 313 (when included), and the I/O interface 309 are well-known components of conventional communication devices. For example, when the remote programming device 105 is a wireless device, the transmitter 307 and the receiver 313 may be implemented as described above with respect to the transmitter 211 and the receiver 213 of wireless device 101. In such a case, the I/O interface 309 would be implemented as an antenna and, if necessary, isolation circuitry (e.g., isolator, circulator and/or antenna switch). Alternatively, when the remote programming device 105 is a conventional wireline device, such as a personal computer (PC) or server, the transmitter 307 and receiver 313 are preferably implemented as an internal or external modem, and the I/O interface 309 is preferably implemented as a conventional data port interface (e.g., telephone line interface, cable interface, digital subscriber line (DSL) interface, integrated digital services network (ISDN) interface, and so forth).

The user interface 305, when included, may be any conventional user interface mechanism, including without limitation, a keypad, a touchscreen, a keyboard, a joystick, a rollerball, a thumbwheel, a set of scroll buttons, a graphical user interface (GUI), a mouse, or any combination of the foregoing devices. In the event that the remote programming device 105 supports voice-activated operation or is a two-way wireless voice-capable device, the user interface 305 may include a microphone(s) or other acoustic receptor(s) and appropriate commercially-available software to facilitate such operation.

The display 315, when included, preferably comprises an LCD, an electronic ink display, an LED display, an OLED display, a liquid plasma display, a cathode ray tube (CRT), or any other conventional electronic display. The display 315 may be implemented as a single display or as a combination of displays.

The power source 311 may comprise a regulated AC-DC converter, a DC regulator, a single battery, an arrangement of batteries, one or more fuel cells or any other DC power source depending on whether the remote programming device 105 operates on DC power alone, or receives AC power and must perform a conversion to obtain DC power. The power source 311 supplies DC power for use by all the electrical components of the remote programming device 105.

Referring now to FIGS. 1-3, operation of the exemplary wireless communication system 100 occurs substantially as follows in accordance with the present invention. In the event that the wireless communication device 101 is lost or stolen, the owner of the wireless device 101 preferably accesses a remote programming device 105 for use in OTA programming the lost device 101. For purposes of the following discussion, the remote programming device 105 used by the wireless device owner will be a server hosted by or on behalf of the wireless device's wireless service provider and coupled to the Internet 109. Using a PC, the wireless device owner accesses the owner's account from the wireless service provider's website on the server 105. Once in the account, the owner uses his or her PC to select an option for OTA programming a lost or stolen device. Upon entering the OTA programming area, the device owner inputs a restrictive mode activation password and, if necessary, an additional message or instructions for transmission to the wireless device 101. The inputted text is supplied over the Internet 109, and through the server's I/O interface 309 and receiver 313 (e.g., modem), to the server's processor 301.

Responsive to receiving the text, the server's processor 301, executing operating instructions stored in memory 303, generates a data message that includes the password and the supplied instructions, if any. The data message effectively instructs the wireless device 101 to begin operating in a restrictive operating mode as described in detail below. The processor 301 also preferably formats the data message for transmission either to the wireless infrastructure 103 directly or to some intermediate network 109 (e.g., the Internet). The formatted message is transmitted by the server's transmitter 307 (e.g., modem) to the wireless infrastructure 103 directly, or indirectly through the intermediate network 109. The wireless infrastructure 103 then processes and reformats the message in accordance with known techniques to create a wireless data message that is understandable by the wireless device 101, and transmits the wireless data message to the wireless device 101 over an appropriate wireless channel 111, 112 (e.g., traffic channel 111 if a packet data or short message service (SMS) message is used, or control channel 112 if a control channel message is used). The wireless infrastructure may temporarily store the message for transmission in the event that the wireless device 101 is not currently registered or active in the system 100.

As an alternative to the device owner attempting to contact the lost or stolen communication device 101 directly, the device owner may instead contact his or her wireless service provider to report the device 101 lost or stolen. In this case, the remote programming device 105 may be a PC operated by the wireless service provider's customer support personnel. In this embodiment, the wireless service provider representative creates a message that includes the restrictive mode activation password using the PC's keyboard 305. The message is received by the PC's processor 301 and is formatted by the processor 301 into a data message in accordance with programming instructions stored in memory 303. The data message is supplied to the PC's transmitter 307 (e.g., modem) and subsequently transmitted through the PC's I/O interface 309 to the wireless infrastructure 103 either directly or through an intermediate network 109. The wireless infrastructure 103 then processes and reformats the message in accordance with known techniques to create a wireless data message for transmission to the wireless device 101.

In yet another embodiment, the device owner may access an automated voice menu system hosted by the device's wireless service provider. In this case, the device owner uses his touchtone phone to select the menu options for placing the wireless device 101 in the restrictive operating mode and entering the restrictive mode activation password that is ultimately sent to the wireless device 101 via the wireless infrastructure 103.

In still a further embodiment, the remote programming device 105 may be a landline or wireless telephone that, responsive to user input, places a call to the lost or stolen communication device 101 and that, responsive to subsequent user input, transmits the restrictive mode activation password after the lost device 101 or its associated voice mail server answers the call. In this case, after the call is answered by the voice mail system or the possessor of the device, the device owner may use his telephone to enter the restrictive mode activation password and/or restricted target device contact information for delivery to the wireless device 101 through the wireless infrastructure 103.

The restrictive mode activation message transmitted from the remote programming device 105 via the wireless infrastructure 103 is intercepted by the wireless device antenna 209, and supplied to the wireless device's receiver 213. The receiver 213 demodulates, decodes and otherwise processes the received message in accordance with known techniques, and supplies the received data stream to the wireless device processor 201. The wireless device processor 201, executing operating instructions stored in program memory 203, extracts the password and compares the received password with the restrictive mode activation password stored in memory 205. The restrictive mode activation password is preferably stored in memory 205 by the wireless service provider at the time of original device activation and provisioning, by the wireless device manufacturer at the time of device fabrication, or by the wireless device owner through use of the device's user interface 219 prior to the device 101 being lost or stolen.

In an alternative embodiment, the device owner or authorized user may enter the restrictive mode activation password into the wireless device 101 via the user interface 219 as a precautionary measure. For example, in the event that the device user intends to leave the wireless device 101 in a location (e.g., the user's car) that is more conducive to theft, the device user may enter the restrictive mode activation password into the wireless device 101 to preemptively place the wireless device 101 into the restrictive operating mode for security purposes.

In the event that the password received from the wireless infrastructure 103 or from the wireless device user matches the restrictive mode activation password stored in memory 205, the wireless device processor 201 automatically places the wireless communication device 101 in a restrictive operating mode. Once in the restrictive operating mode, the wireless device processor 201 will permit the wireless communication device 101 to initiate communications only with restricted target devices 107 that are identified in the received message or for which contact information has been previously stored in memory 204. For example, in one embodiment in which the password is received from the remote programming device 105 via the wireless infrastructure 103, the wireless device processor 201 automatically initiates a communication with the restricted target device 107 upon placing the wireless device 101 in the restrictive operating mode. In such a case, upon determining that the received password matches the restrictive mode activation password stored in memory 205, the wireless device processor 201 automatically initiates a communication (e.g., places a phone call or sends a data message) via the device's transmitter 211 with the first listed target device 107 stored in memory 204 (if so stored) or indicated in the received message that included the restrictive mode activation password. The remote target device's receiver (e.g., receiver 313 when the remote programming device 105 doubles as the first listed target device 107 as is the case when the wireless service provider is both the activator of the restrictive operating mode and the main point of contact for the device possessor) receives the communication from the wireless device 101 and forwards it to the processor (e.g., processor 301) for processing and provision to the target device user through the target device's display (e.g., in the case of a data message) or audio transducer (e.g., in the case of a voice message).

The above-described embodiment effectively forces the possessor of the lost or stolen device 101 to notify the identified target device 107 (e.g., device owner or wireless service provider) immediately upon receipt of the restrictive mode activation password, thereby rapidly providing the device owner or wireless service provider an opportunity to work with the individual in possession of the device 101 to devise a plan for the device's safe return. In the event that the device 101 includes a GPS receiver 221 and antenna 223, the message (e.g., data message) transmitted to the restricted target device 107 may also include the location of the device 101 as determined by the device processor 201 using the GPS software stored in memory 207 based on one or more GPS signals received by the GPS receiver 221. In such a case, the computed location can be used by the device owner, the wireless service provider and/or proper authorities to locate and retrieve the device 101.

In another embodiment, the wireless device processor 201 may automatically initiate a communication with a restricted target device 107, but only if the possessor of the device 101 attempts to initiate a communication using the device 101 (e.g., tries to make a call). That is, in this embodiment, the wireless device processor 201, after placing the device 101 in the restrictive operating mode, may allow the device 101 to be used for various local purposes (e.g., to provide time, to play games, to listen to ring tones or music, and so forth), but will not allow the device 101 to be used to make calls or send messages other than to one of the restricted target devices 107. While providing more flexibility to and putting more trust in the possessor of the device 101, this embodiment still operates to put the possessor of the device 101 in contact with the device's owner or wireless service provider as soon as the device possessor is ready to place a call.

In yet another embodiment or in any of the previously described embodiments, the wireless device processor 201 may automatically sound an audible alert (e.g., a series of beeps or chirps, a continuous tone or a synthesized voice message) via the audio transducer 217 upon receiving the restrictive mode activation password and placing the device 101 in the restrictive operating mode. The audible alert would preferably serve to help locate the device 101 and potentially deter unauthorized use of the device 101.

In a further embodiment or in any of the previously described embodiments, the wireless device processor 201 may, upon receiving the restrictive mode activation password and placing the wireless device 101 into the restrictive operating mode, automatically retrieve previously stored contact information from memory 204 and display the contact information on the device display 215. The contact information is preferably stored in memory 204 at approximately the same time as the restrictive mode activation password is stored in memory 205 (e.g., during execution of a software application that receives and stores, in a defined sequence, the contact information and the password).

Alternatively, when the contact information forms part of the contents of the received message instead of or in addition to being stored in memory 204. In this case, the wireless device processor 201 may, upon placing the device 101 in the restrictive operating mode, display the contact information that was received as part of the restrictive mode activation message transmitted by the remote programming device 105. Thus, in this embodiment, the device 101 displays the contact information (e.g., phone number, name, IP address, private ID, email address, and so forth optionally together with instructions for placing a call or sending a data message) for one or more of the restricted target devices 107 in an attempt to provide the possessor of the device 101 with sufficient information to contact the owner of the device 101, the device's wireless service provider, or both, and to encourage the possessor to make such contact.

If, after displaying the contact information, the device processor 201 receives an input from the possessor of the device 101 (e.g., the digits for the phone number displayed in the contact information) indicating a desire to initiate a communication with a restricted target device 107, the device processor 201 preferably performs all necessary call-setup functions to initiate the requested communication with the target device 107. Such call set-up functions are well known; thus, no further discussion of them will be presented except to facilitate an understanding of the invention.

While a single restrictive mode activation password is depicted as being stored in the wireless device 101 of FIG. 2, one of ordinary skill in the art will readily appreciate that multiple such passwords may be stored in the device's memory to enable the wireless device 101 to be placed in various levels of restricted operation so long as each level of restricted operation only permits the wireless device 101 to initiate communications with one or more identified target devices 107. For example, one password may be associated with an automatic placement of a call to a restricted target device 107 and automatic transmission of the device's location (if the device 101 is GPS-capable) upon the wireless device's receipt of the particular password. This level or mode of restricted operation may be activated when the device 101 is suspected of being stolen. Alternatively, if the device is only suspected of being lost, the password transmitted to the device 101 may force the device 101 into a mode in which the device 101 automatically places a call to a restricted device 107 only if the possessor of the device 101 tries to make a call or send a data message (i.e., initiate a communication) with a device other than one of the restricted target devices 107.

In the event that the lost or stolen device 101 is eventually returned to its owner or the owner's designee (e.g., wireless service provider), the owner or designee preferably inputs a new password into the device 101 either via the device's user interface 219 or via a wireless message transmitted over the control channel 112 or a traffic channel 111 to return the device 101 to normal operation. Upon receiving this subsequent password and/or message, the wireless device processor 201 compares the password to the restrictive mode de-activation password previously stored in memory 206 and, when a match occurs, returns the wireless device 101 to a normal mode of operation in which the device 101 is not limited to contacting restricted target devices 107. The password for returning the wireless device 101 to its normal operating mode may be a password that is different than the password used to activate the restrictive operating mode or may be the same password as that which was used to activate the restrictive operating mode. In the case where the activation and de-activation passwords are the same, the operating instructions executed by the wireless device processor 201 instruct the processor 201 to activate the restrictive operating mode upon first receiving the password and then de-activate the restrictive operating mode upon subsequently receiving the password. After normal operation has been reestablished, subsequent receipt of the password would cause the processor 201 to reactivate the restrictive operating mode.

To provide the restrictive mode de-activation password remotely, the user of the remote programming device 105 enters the de-activation password using the device's user interface 305 (e.g., keyboard or keypad) during execution of an applicable software program. The entered password is received by the processor 301 and used create a restrictive mode de-activation message. The de-activation message, which may include the password alone or may include other instructions for the wireless device 101, is forwarded to the transmitter 307 and transmitted therefrom to the wireless device 101 via the remote device's I/O interface 309 and the wireless infrastructure 103. The de-activation message effectively instructs the wireless device 101 to resume operating in its normal operating mode. After transmission, the de-activation message is intercepted by the wireless device antenna 209 and supplied to the wireless device's processor 201 after applicable processing by the device's receiver 213. The device processor 201 then performs the aforementioned password comparison and returns the device 101 to its normal operating mode if a password match is detected.

As discussed above, the present invention provides a wireless communication system and constituent apparatuses that provide for placing a wireless communication device into a restrictive operating mode in the event that the device is lost or stolen or as a precautionary measure. Once placed into such a mode, the wireless device is limited to communicating only with certain target devices as indicated in the message placing the device in the restrictive operating mode or as previously stored in the device's memory. The target devices that the wireless device is permitted to contact while operating in the restrictive operating mode are preferably devices belonging to or operated by the owner or wireless service provider of the lost/stolen device. By limiting operation of the lost/stolen device to such an operating mode, the present invention enables a finder of the device to easily contact those individuals or entities that are most interested in the safe return of the device, while preventing unscrupulous finders or thieves from using the lost/stolen device in an unauthorized manner.

FIG. 4 is a logic flow diagram 400 of steps executed by a wireless communication device to implement security in accordance with a preferred embodiment of the present invention. The logic flow begins (401) when the wireless device receives and stores (403) a restrictive mode activation (RMA) password. The RMA password may be input by the device manufacturer during device fabrication, by the device's wireless service provider during device activation and provisioning, or by the device owner or user through the device's user interface prior to the device being lost or stolen. In the optional event that a separate restrictive mode de-activation (RMD) password is used to return the wireless device to normal operation after operating in the restrictive operating mode, the wireless device receives and stores (405) the RMD password. Similar to the input of the RMA password, the RMD password, when used, may be input by the device manufacturer during device fabrication, by the device's wireless service provider during device activation and provisioning, or by the device owner or user through the device's user interface prior to the device being lost or stolen. Alternatively, the RMD password may be identical to the RMA password, in which case, receipt of the RMA password when the device is operating in its normal operating mode is interpreted as an instruction to place the wireless device in a restrictive operating mode; whereas, receipt of the RMA password when the device is operating in its restrictive operating mode is interpreted as an instruction to place the wireless device back in its normal operating mode, as described in more detail below. The RMA and RMD passwords may each be any alphanumeric, character or digit string, such as a conventional password, passcode or personal identification number (PIN). The RMA password is associated with permitting a remote device to control the wireless device in such as way so as to place the wireless device into a restrictive operating mode as described below. The RMD password is associated with remotely or locally controlling the wireless device in such as way so as to return the wireless device to its normal operating mode.

Some time after storing the RMA password (and optionally the RMD password), the wireless device receives (407) input from the device user or a message (e.g., a control channel message, a packet data message or a short message service (SMS) message) from a remote device, such as the remote programming device 105 described above with respect to FIGS. 1 and 3, via the wireless infrastructure. The wireless device determines (409) whether the received input or message includes the RMA password by preferably comparing the contents of the received input or message with the previously stored RMA password.

In the event that the received message or input includes the RMA password, the wireless device automatically places (411) itself in a restrictive operating mode in which it may only initiate a communication with one or more restricted target devices. That is, once the wireless device is placed in the restrictive operating mode in accordance with the present invention, the wireless device's operational software will only permit the device to place calls or send messages to the restricted target device(s). Notwithstanding the foregoing, the wireless device may still be used for other purposes, such as to supply the time of day, to play games or run other local applications that may be stored on the device, and to listen to music or ring tones stored on the device, just to name a few. Alternatively, the wireless device may be programmed to prohibit all use of the wireless device except for contacting the restricted target device(s) once the device is placed in the restrictive operating mode. The identities and contact information of the restricted target device(s) are preferably stored in the wireless device by the device's owner or wireless service provider prior to receipt of the message containing the RMA password, but may optionally be included in such message.

After placing itself in the restrictive operating mode, the wireless device may perform several optional operations based solely on being placed in the restrictive operating mode or based on receipt of other passwords (e.g., passwords received from a remote programming device after the device has been placed in the restrictive operating mode responsive to user interface input). For example, the wireless device may sound (413) an audible alert using conventional techniques to help the device user or others locate the wireless device and/or deter a thief from maintaining possession of the device. Alternatively or additionally, the wireless device may display (415) contact information and/or instructions for contacting the restricted target device(s). For instance, if the wireless device has packet data messaging capability, the device might display the customer service email address of the device's wireless service provider and instructions on how to construct and send an email message from the device. Alternatively, the wireless device might simply display the customer service telephone number of the device's wireless service provider or a telephone number at which the device owner can be reached.

Further, the wireless device may automatically initiate (417) a communication (e.g., place a call or send a data message) with a restricted target device, thereby automatically initiating contact with the device owner or its designee (e.g., wireless service provider) in an attempt to facilitate a return of the lost or stolen device. To initiate such a communication, the wireless device, upon being placed in the restrictive operating mode, preferably retrieves the contact information of the restricted target device from memory or from the message instructing the device to activate the restrictive operating mode. After obtaining the necessary contact information, the wireless device initiates the communication in accordance with the conventional channel request and access procedures that are used in the wireless system in which the device operates.

Still further, instead of automatically initiating a communication with a restricted target device, the wireless device may initiate (417) such a communication responsive to any attempt by the device possessor to initiate another communication (e.g., use the device to place a call or send a message) or responsive to the possessor's input after displaying the contact information for one or more restricted target devices. For example, when displaying the contact information, the wireless device may also display text, such as “CALL NOW”, adjacent a key or button that has been setup in software as a function key for calling or initiating a communication with the restricted target device identified on the display. Responsive to the possessor's depression of the key or button, the wireless device preferably initiates a communication with the restricted target device.

Still further, the wireless device may, after being placed in the restrictive operating mode, automatically transmit (419) a message to the device's wireless service provider to inform the wireless service provider that it has been placed in the restrictive operating mode. If the wireless device is GPS-capable, the message transmitted to the wireless service provider may also include the location of the device to assist the wireless service provider, device owner and/or law enforcement authorities in locating the device. After the lost or stolen wireless device has been placed in the restrictive operating mode and, if so programmed, executed one or more of the optional processes described above with respect to blocks 413-419, or other optional processes, the logic flow ends (421).

Referring back to decision block 409, in the event that the message received from the remote device does not include the RMA password, the wireless device determines (423) whether the message or user input includes the RMD password. In the event that the received message includes the RMD password or the wireless device has received (e.g., via its user interface) the RMD password from the device user (e.g., owner), the wireless device terminates (425) the restrictive operating mode and the logic flow ends (421). By terminating the restrictive operating mode, the wireless device returns itself to its normal operating mode in which the wireless device is not limited to contacting the restricted target device(s). As noted above, the RMD password may be identical to the RMA password. Therefore, in the event that the wireless device is already in the restrictive operating mode, subsequent receipt of the RMA password or receipt of a unique RMD password either via an OTA message (e.g., from the device's wireless service provider) or via the device's user interface is preferably sufficient to instruct the wireless device to resume operating in its normal operating mode. In an alternative embodiment, the restrictive mode may be terminated by the contents of the received message without the need for an RMD password. For example, the contents of an SMS or packet data message may expressly instruct the wireless device to return to its normal operating mode without including the RMD password.

In the event that the received message does not include an RMA password to place the device in the restrictive operating mode or an RMD password to return a wireless device operating in the restrictive operating mode back to its normal operating mode, the wireless device processes (427) the received message in its normal operating mode and the logic flow ends (421). That is, if the wireless device is operating normally and receives a message that does not instruct the device directly or indirectly (e.g., through inclusion of an RMA password) to operate in the restrictive operating mode, the wireless device simply processes the message in the ordinary course using conventional techniques.

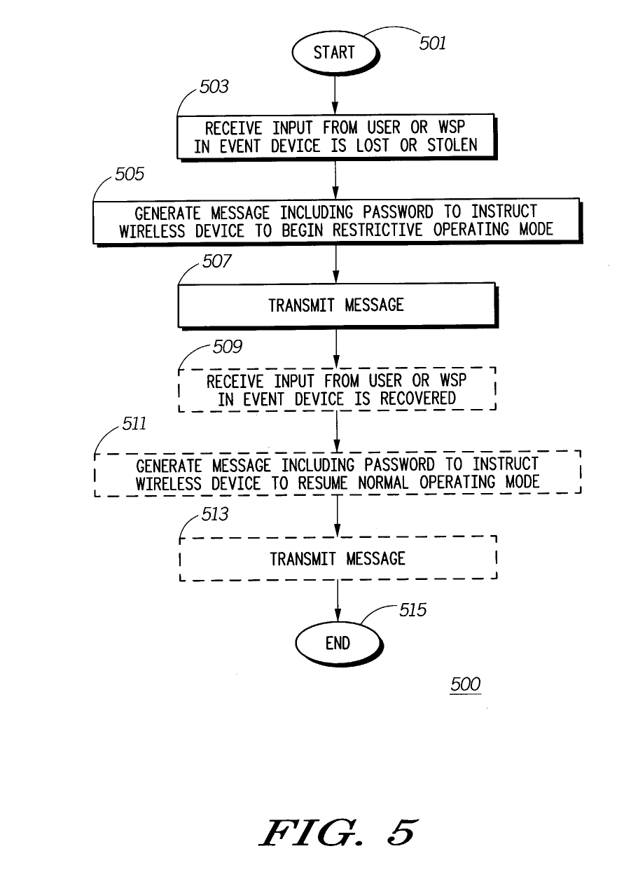

FIG. 5 is a logic flow diagram 500 of steps executed by a remote programming device to remotely activate a restrictive operating mode of a wireless communication device in accordance with a preferred embodiment of the present invention. As noted above with respect to FIGS. 1 and 3, the remote programming device may be a server, a personal computer, a wireless device or any other device or combination of devices that at least perform the operations set forth in blocks 501-507 of FIG. 5. The logic flow begins (501) when the remote programming device receives (503) input from a user of the wireless communication device and/or a representative of the wireless device's wireless service provider (WSP) in the event that the wireless device is lost or stolen. The input preferably includes a restrictive mode activation password that was previously stored within the wireless device. The input may also include contact information for one or more restricted target devices with which the wireless device may only communicate after being placed in a restrictive operating mode as contemplated by the present invention. For example, the input to the remote programming device may include the contact information for all the restricted target devices, some of them (e.g., when the contact information for the other restricted target devices is stored in the wireless device) or none of them (e.g., when the contact information for all the restricted target devices is stored in the wireless device).

Responsive to the received input, the remote programming device generates (505) a message (e.g., a control channel message, a packet data message or an SMS message) that includes the restrictive mode activation password and is adapted to instruct the wireless device to begin operating in a restrictive operating mode. Once in the restrictive operating mode, the wireless device will be capable of contacting one or more restricted target devices only, as determined by contact information stored in the wireless device and/or forming part of the contents of the message. In addition to instructing the wireless device to begin operating in the restrictive operating mode, the message may also instruct the wireless device to perform other functions, such as sound an audible alert and display the contact information for the restricted target device(s). After generating the message, the remote programming device transmits (507) the message to the wireless device via an appropriate wireless infrastructure network and any intermediate networks in accordance with known techniques.

In the event that the lost or stolen wireless device is eventually recovered, the remote programming device may optionally be used to return the wireless device to its normal operating mode. In such a case, the remote programming device receives (509) an input from the user of the wireless communication device and/or a representative of the wireless device's wireless service provider. In this case, the input includes a restrictive mode de-activation password. As discussed above, the restrictive mode de-activation password may be identical to the restrictive mode activation password in the event that the wireless device is programmed to treat receipt of the restrictive mode activation password as receipt of the restrictive mode de-activation password when the wireless device is already operating in the restrictive operating mode.

Responsive to receiving the restrictive mode de-activation password and other inputs from the user of the wireless communication device and/or a representative of the wireless device's wireless service provider, the remote programming device generates (511) a message that includes the restrictive mode de-activation password and is adapted to instruct the wireless device to resume operating in its normal operating mode in which the wireless device is not limited to contacting the restricted target device(s). After generating the message, the remote programming device transmits (513) the message to the wireless device via an appropriate wireless infrastructure network and any intermediate networks in accordance with known techniques, and the logic flow ends (515).

The present invention encompasses a method and apparatus for remotely activating a restrictive operating mode of a wireless communication device in the event that the wireless device is lost or stolen. With this invention, operation of the lost or stolen wireless device is severely limited, but not prohibited, in order to facilitate a prompt return of the device to its rightful owner. That is, pursuant to the present invention, the lost or stolen wireless device is remotely placed into an operating mode in which the device can initiate a communication with only a limited number of target devices. Such target devices are preferably associated with the device's owner and/or wireless service provider. Thus, once in the restricted mode, the wireless device can call or send messages to the limited number of target devices in order to permit the possessor or finder of the lost device to contact the device's owner or designee, but cannot be used at the whim of the possessor to incur substantial wireless service fees. By providing wireless device security in this manner, the present invention increases the chances that the device owner will recover his or her lost or stolen wireless device, without completely prohibiting use of the wireless device as in the prior art and while mitigating wireless service charges that could otherwise be incurred through unauthorized use of the wireless device.

In the foregoing specification, the present invention has been described with reference to specific embodiments. However, one of ordinary skill in the art will appreciate that various modifications and changes may be made without departing from the spirit and scope of the present invention as set forth in the appended claims. For example, the remote programming device 105 and the restricted target device 107 may be one and the same device or set of devices, and may be coupled to the wireless infrastructure 103 directly (e.g., via Ti or other dedicated transmission lines) or indirectly (e.g., via one or more intermediate networks 109). Accordingly, the specification and drawings are to be regarded in an illustrative rather than a restrictive sense, and all such modifications are intended to be included within the scope of the present invention.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not to be construed as a critical, required, or essential feature or element of any or all the claims. As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus.

What is claimed is:

1. A method for remotely activating a restrictive operating mode of a wireless communication device in the event that the wireless communication device is lost or stolen, the method comprising:
receiving an input from at least one of a user of the wireless communication device and a wireless service provider supplying wireless communication services to the wireless communication device in the event that the wireless communication device is lost or stolen, the input including a password;
generating a message responsive to the input, the message including the password and being adapted to instruct the wireless communication device to begin operating in a restrictive operating mode in which the wireless communication device is only capable of contacting a restricted target device as determined by at least one of contact information stored in the wireless communication device and contents of the message; and
transmitting the message to the wireless communication device.

2. The method of claim 1, further comprising:
receiving a second input from one of the user of the wireless communication device and the wireless service provider, the second input including a second password;
generating a second message responsive to the second input, the second message including the second password and being adapted to instruct the wireless communication device to resume operating in a normal operating mode in which the wireless communication device is not limited to contacting the restricted target device; and
transmitting the second message to the wireless communication device.

3. The method of claim 1, wherein generating a message further comprises:
generating a message that instructs the wireless communication device to sound an audible alert.

4. The method of claim 1, wherein generating a message further comprises:
generating a message that instructs the wireless communication device to display the contact information.

5. A method for implementing security in a wireless communication device, the method comprising:
storing a first password associated with permitting remote control of the wireless communication device;
receiving a message from a remote device;
determining whether the message includes the first password; and
in the event that the message includes the first password, automatically placing the wireless communication device in a restrictive operating mode in which communication may be initiated only with a restricted target device as determined by at least one of pre-stored contact information and contents of the message.

6. The method of claim 5, further comprising:
automatically initiating a communication with a restricted target device responsive to any attempt by a possessor of the wireless communication device to initiate a communication after the wireless communication device has begun operating in the restrictive operating mode.

7. The method of claim 5, further comprising:
storing a second password, the second password being associated with returning the wireless communication device to a normal operating mode in which the wireless communication device is not limited to contacting a restricted target device;
receiving one of a second message and user input after the wireless communication device has begun operating in the restrictive operating mode to produce a received instruction; and
automatically terminating the restrictive operating mode in the event that the received instruction includes the second password.

8. The method of claim 5, further comprising:
automatically sounding an audible alert responsive to placing the wireless communication device in the restrictive operating mode.

9. The method of claim 5, further comprising:
automatically displaying the contact information responsive to placing the wireless communication device in the restrictive operating mode.

10. The method of claim 9, further comprising:
initiating a communication with a restricted target device after displaying the contact information and responsive to input by a possessor of the wireless communication device.

11. The method of claim 5, further comprising:
automatically displaying instructions for contacting a restricted target device responsive to placing the wireless communication device in the restrictive operating mode.

12. The method of claim 5, further comprising:
automatically transmitting a message to a wireless service provider responsive to placing the wireless communication device in the restrictive operating mode.

13. The method of claim 12, wherein the wireless communication device includes a global positioning satellite (GPS) receiver and associated software for determining a location of the wireless communication device based on at least one signal received by the GPS receiver, and wherein automatically transmitting a message further comprises:
automatically transmitting a message that includes the location of the wireless communication device.

14. A method for implementing security in a wireless communication device, the method comprising:
storing a first password associated with restricted operation of the wireless communication device;
receiving input from a user of the wireless communication device;
determining whether the input includes the first password; and
in the event that the input includes the first password, automatically placing the wireless communication device in a restrictive operating mode in which communication may be initiated only with a restricted target device as determined by at least one of pre-stored contact information and contents of the input.

15. A wireless communication device comprising:
means for storing contact information for at least one restricted target device;
means for storing a restrictive mode activation password associated with restricted operation of the wireless communication device;
means for receiving at least one of a message from a remote device and input from a user of the wireless communication device;
means for determining whether at least one of the message and the input includes the restrictive mode activation password; and
means for automatically placing the wireless communication device in a restrictive operating mode in which communication may be initiated only with the at least one restricted target device in the event that at least one of the message and the input includes the restrictive mode activation password.

16. A wireless communication device comprising:
a first memory that stores a first password associated with permitting remote control of the wireless communication device;
a receiver that receives a message from a remote device;
a processor operably coupled to the first memory and the receiver; and
a program memory operably coupled to the processor, the program memory including operating instructions that, when executed by the processor, cause the processor to:
determine whether the message includes the first password; and
automatically place the wireless communication device in a restrictive operating mode in which communication may be initiated only with a restricted target device in the event that the message includes the first password.

17. The wireless communication device of claim 16, further comprising a transmitter operably coupled to the processor, wherein the operating instructions stored in the program memory further cause the processor to:
automatically initiate a communication with a restricted target device via the transmitter responsive to any attempt by a possessor of the wireless communication device to initiate a communication after the wireless communication device has begun operating in the restrictive operating mode.

18. The wireless communication device of claim 16, further comprising an audio transducer operably coupled to the processor, wherein the operating instructions stored in the program memory further cause the processor to:
automatically sound an audible alert through the audio transducer responsive to the wireless communication device being placed in the restrictive operating mode.

19. The wireless communication device of claim 16, further comprising:
a display operably coupled to the processor; and
a second memory, operably coupled to the processor, that stores contact information for at least one restricted target device;
wherein the operating instructions stored in the program memory further cause the processor to:
automatically display the contact information on the display responsive to the wireless communication device being placed in the restrictive operating mode.

20. The wireless communication device of claim 19, further comprising a user interface operably coupled to the processor, wherein the operating instructions stored in the program memory further cause the processor to:
initiate a communication with the at least one restricted target device after displaying the contact information and responsive to input received from a possessor of the wireless communication device via the user interface.

21. The wireless communication device of claim 16, further comprising a transmitter operably coupled to the processor, wherein the operating instructions stored in the program memory further cause the processor to:
automatically transmit a second message to a wireless service provider via the transmitter responsive to the wireless communication device being placed in the restrictive operating mode.

22. The wireless communication device of claim 21, further comprising a global positioning satellite (GPS) receiver operably coupled to the processor, wherein the operating instructions stored in the program memory further cause the processor to:
determine a location of the wireless communication device based on at least one signal received by the GPS receiver; and
generate the second message to include the location of the wireless communication device.

23. An apparatus for remotely activating a restrictive operating mode of a wireless communication device in the event that the wireless communication device is lost or stolen, the apparatus comprising:
a processor that generates a message responsive to input from at least one of a user of the wireless communication device and a wireless service provider supplying wireless communication services to the wireless communication device, the message including a password and being adapted to instruct the wireless communication device to begin operating in a restrictive operating mode in which the wireless communication device is only capable of contacting a restricted target device as determined by at least one of contact information stored in the wireless communication device and contents of the message; and
a transmitter, operably coupled to the processor, that transmits the message to the wireless communication device.

24. The apparatus of claim 23, wherein the processor receives a second input from one of the user of the wireless communication device and the wireless service provider, and further generates a second message responsive to the second input, the second message including a second password and being adapted to instruct the wireless communication device to resume operating in a normal operating mode in which the wireless communication device is not limited to contacting a restricted target device; and wherein the transmitter transmits the second message to the wireless communication device.

25. The apparatus of claim 23, wherein the message further instructs the wireless communication device to at least one of sound an audible alert and display the contact information.

26. The apparatus of claim 23, further comprising:
a receiver, operably coupled to the processor, that receives a communication from the wireless communication device after transmission of the message when the apparatus is a restricted target device.

27. A wireless communication system comprising:
a wireless communication device that includes:
a first memory that stores a first password associated with permitting remote control of the wireless communication device;
a receiver that receives a message;
a first processor operably coupled to the first memory and the receiver; and
a program memory operably coupled to the first processor, the program memory including operating instructions that, when executed by the first processor, cause the first processor to:
determine whether the message includes the first password; and
automatically place the wireless communication device in a restrictive operating mode in which communication may be initiated only with a restricted target device as determined by at least one of contact information stored in a second memory and contents of the message in the event that the message includes the first password; and
an apparatus for remotely activating the restrictive operating mode of the wireless communication device, wherein the apparatus includes:
a second processor that generates the message responsive to input from at least one of a user of the wireless communication device and a wireless service provider supplying wireless communication services to the wireless communication device, the message including the first password and being adapted to instruct the wireless communication device to begin operating in the restrictive operating mode; and
a transmitter, operably coupled to the processor, that transmits the message to the wireless communication device.
